(19) United States
(12) Patent Application Publication
(10) Pub. No.: US 2003/0037809 A1
(43) Pub. Date: Feb. 27, 2003

(54) Diswashing machine provided with an electric-hydraulic functional unit

(76) Inventor: Daniele Favaro, Pramaggiore (IT)

Correspondence Address: PEARNE & GORDON LLP, 526 SUPERIOR AVENUE EAST, SUITE 1200, CLEVELAND, OH, 44114-1484, US

(21) Appl. No.: 10/169,689

(22) PCT Filed: Jan. 8, 2001
(86) PCT No.: PCT/EP01/00099

(30) Foreign Application Priority Data
Feb. 15, 2000 (IT) PN2000A000011

(51) Int. Cl. B08B 3/00

(52) U.S. Cl. 134/58 D

(57) ABSTRACT

Dishwashing machine comprising an outer casing (1) enclosing an internal washing vessel (2) that is capable of being closed frontally by a door (3) and accommodates support means (6, 7) for the washload items, a well as associated rotating spray arms (9, 11, 12) for spraying the washing liquor. According to the invention, a functional unit (15) is provided which comprises an enclosure (16, 17) that is removably attached to the washing vessel (2) and houses in its interior at least a great majority of the electric-hydraulic component parts of the washing machine, in particular at least an electric washing pump (21) and an electric drain pump (31), as well as at least a heating element (30) for the washing liquor.

### DESCRIPTION

The present invention refers to a dishwashing machine, particularly, although not solely intended for home use.

Dishwashing machines are generally known to comprise an outer casing which encloses an inner washing vessel and closing door that is generally arranged on the front side. Dishwashing machines also comprise a variety of component parts, including electric and hydraulic, ie. water-handling parts (such as circulating and drain pumps, heating elements and the like), almost all, if not all of which that are arranged in the lower zone of the machines, ie. underneath the bottom of the washing vessel.

On the production line of these washing machines, the above cited electric and hydraulic component parts are currently installed individually, ie. one-by-one, and then interconnected by means of electric conductor leads and pipe connections, respectively. Constructions of this kind have the advantage of being very flexible, ie. quite easily and readily allowing for the introduction of design modifications and/or the derivation of variants, as this is largely known to be required by the totality of complex products having a production life extending throughout several years.

At the same time, however, such a construction is scarcely efficient from an industrial point of view, especially in those cases in which large manufacturing volumes are involved. The arrangement itself of these component parts, when possible repairs and/or replacements thereof are carried out directly in the field, ie. in the home of the end user of the machine, forces furthermore the after-sales service engineers into carrying out awkward operations, such as for instance to heel the dishwashing machine over to one side after possibly having pulled it out of its built-in niche or cabinet.

It therefore is a first purpose of the present invention to improve both the manufacturing efficiency and the serviceability of a dishwashing machine.

On Jun. 1, 1999 this same Applicant has filed the Italian patent application no. PN99A000043 concerning a dishwashing machine featuring an innovative architecture in that the front loading door thereof is so arranged as to be able to slide jointly with both at least one of the racks provided for supporting the washload items and a pan-shaped body that forms both the bottom and the side walls of the washing vessel. Furthermore, the dimensions of the inner surface of the door are such as to accommodate the front bulk of at least a further rack provided to support washload items.

It therefore is a second purpose of the present invention to provide an arrangement of the afore cited electric and hydraulic component parts that is particularly suitable for installation on washing machines having an architecture of the above cited kind.

Also known from the disclosure in EP-A-0 618 779 and the various divisional applications thereof is a dishwashing machine in which, instead of the usual washing vessel, there are provided one or more drawers adapted to be inserted in a water-tight manner inside an outer casing. Each such drawer has a rounded (convex) bottom so as to allow for also washload items with a relatively large vertical size to be placed there for washing A single synchronous electric motor, which has its rotor submerged in the washing liquor on the bottom of each drawer, drives both an upper washing or circulation pump and a lower drain pump. The stator of said motor is situated outside the drawer and separated from the rotor by the scroll of the drain pump. The intake side of the washing pump comprises an annular buffer under the bottom of the drawer and has necessarily a very reduced head, with the resulting risk of malfunctioning or incorrect operation in the case of excessive foam being formed in the washing liquor. The delivery scroll of the same pump is in turn incorporated in the rotating spray arm which has a rounded shape corresponding to the one of the bottom of the drawer.

Although optimized functionally, such a construction is much too rigid owing to the very close interdependence that can readily be appreciated to exist among the afore mentioned electric and hydraulic component parts, so as to make it quite difficult, time-demanding and expensive for design modifications to be introduced and/or variants to be derived.

It therefore is a further purpose of the present invention to do away with construction rigidities of this kind, while of course avoiding to impair the actual functionality of the dishwashing machine.

A dishwashing machine featuring the characteristics as recited in the appended claims is capable of reaching these and further aims, as this will be explained and indicated in the description given below by way of non-limiting example.

Although the invention can actually be applied also to washing machines having a traditional architecture, the description given below refers to a washing machine of the kind disclosed in the already cited Italian patent application no. PN99A000043 (the contents of which shall be intended as being fully incorporated here) and the accompanying drawing, in which:

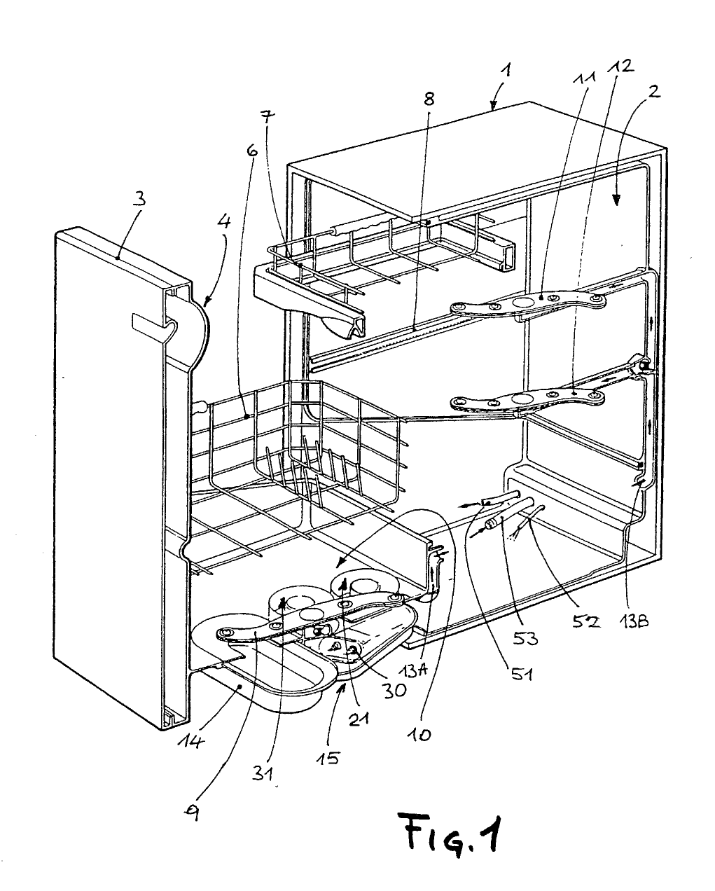

FIG. 1 is a partially three-dimensional and see-through view of a dishwashing machine equipped with a functional electric-hydraulic unit according to the present invention;

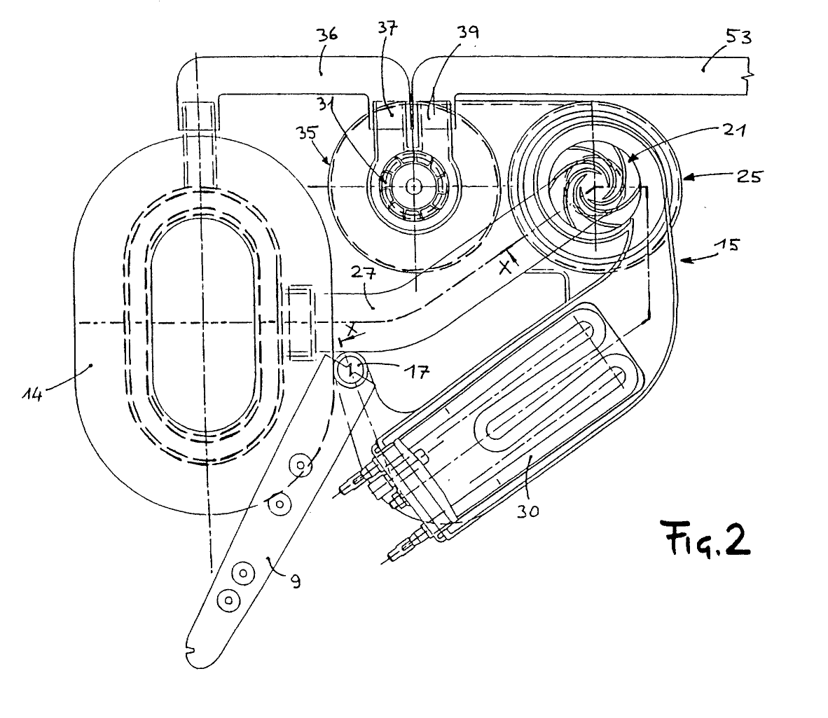

FIG. 2 is a partially see-through top view of the sole functional unit;

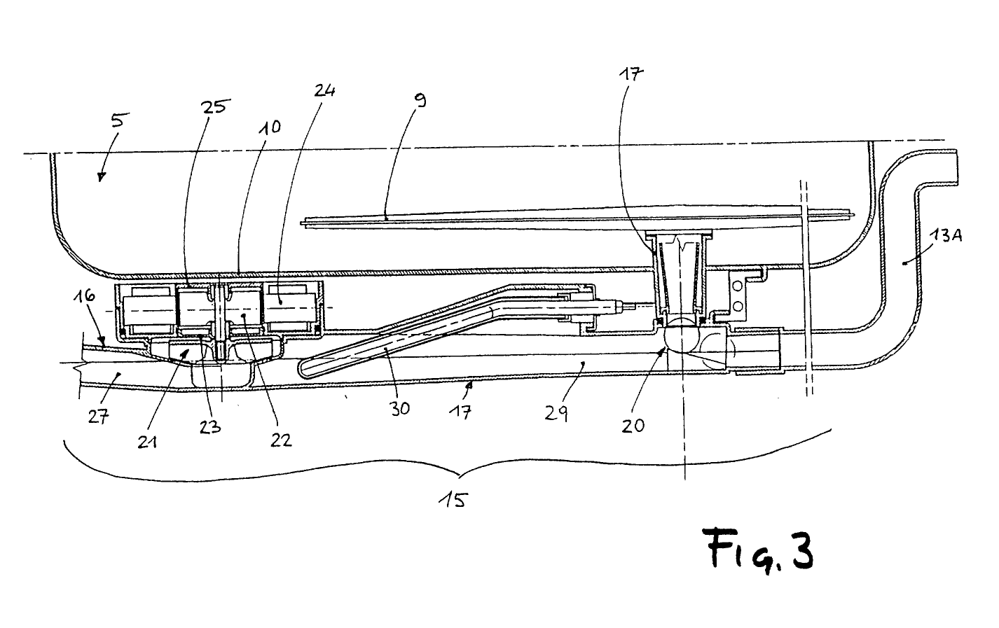

FIG. 3 is an elevational cross-sectional view along the X-X line in FIG. 2;

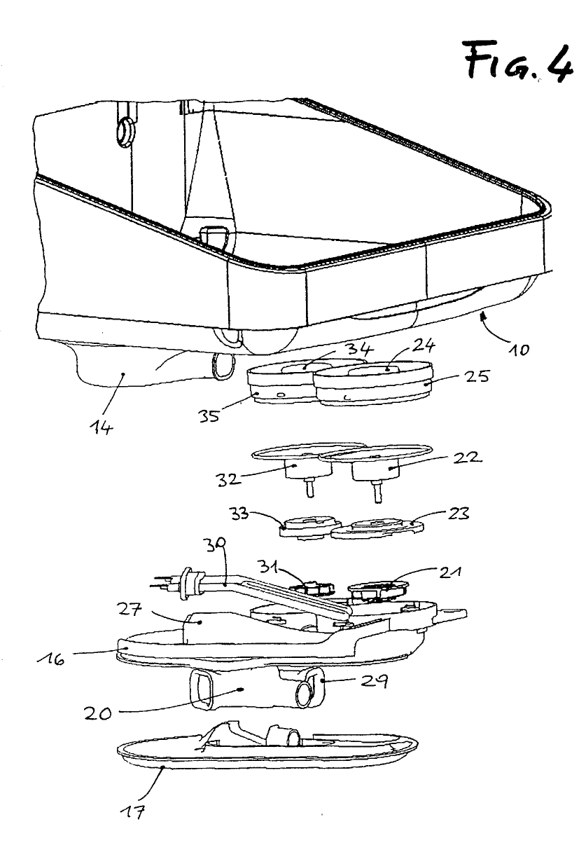

FIG. 4 is a partially exploded view of the functional unit;

As illustrated in the accompanying FIG. 1, the dishwashing machine comprises an outer casing 1 enclosing an inner washing vessel 2 that is capable of being closed by a front door (3) which is adapted to slide horizontally with respect to the outer casing 1.

From the lower zone of the inner surface 4 of the door 3 there extends towards the inner side of the outer casing 1 a body 5 which is substantially in the shape of a pan or the like and forms the bottom of the washing vessel 2.

The dimensions of the inner surface 4 are such as to accommodate the front bulk of three racks intended to support the washload items, ie.: a lower rack 6, which is removably supported by the inner surface 4 itself and is therefore capable of sliding jointly with the door 3; an intermediate rack (not shown) and an upper rack 7, which are on the contrary adapted to slide in the usual manner along longitudinal guides 8 (only one of which is shown in FIG. 1 for reasons of greater simplicity) extending on the vertical side walls of the inner vessel 2.

To the lower rack 6 there is associated a first rotating spray arm 9, which is supported by the bottom 10 of the pan-shaped body 5 and, therefore, is itself adapted to slide jointly with the door 3 with respect to the outer casing 1. To the upper rack 7 and the intermediate rack there are associated two further rotating spray arms, which are indicated at 11 and 12, respectively, and are supported by the back wall of the inner vessel 2.

According to the present invention, the dishwashing machine is provided with a removable functional unit, which is generally indicated at 15, is accessible from the front side of the machine, also by after-sales service engineers or repairmen, upon opening the door 3, and is adapted to enclose at least a great majority of the electric-hydraulic component parts of the machine.

More precisely, said functional unit 15 comprises:

a housing formed by two separable shells 16 and 17, eg. moulded out of a plastic material, and attached under the bottom 10 of the pan-shaped body 5 with the aid of usual fastening means (not shown)—see FIG. 1—and, inside this housing,

the outlet of a telescopic flexible hose 51 for letting in the water flowing from the water supply mains, in which said water flows into the inner vessel 2 through an aperture provided in a water-tight manner in the back wall thereof—see FIG. 1;

a first centrifugal pump 21 and a second centrifugal pump 31, acting as a washing or circulation pump and a drain pump, respectively, arranged behind each other with a vertical axis of rotation, these pumps being described in greater detail further on;

an electric heating element 30 for heating up the washing liquor, said heating element being as usual connected, among other things, with the programme sequence control unit of the machine (not shown, but generally arranged on the front control panel of the dishwashing machine). According to a feature of the present invention, the heating element 30 is advantageously inclined so as to facilitate a possible replacement thereof by the service engineer, without any need arising in this connection for the housing of the functional unit 15 to be separated from the bottom 10 of the pan-shaped body 5—see FIGS. 2 to 4;

a ball valve 20, which is provided to ensure an optimum distribution of the washing liquor among the rotating spray arms 9, 11 and 12, and which may advantageously be made and arranged in accordance with the Italian patent application no, PN99A000058 filed on Jul. 13, 1999 by this same Applicant;

devices (not shown, for reasons of greater simplicity) for controlling and monitoring the level and the temperature of the washing liquor, which are connected electrically, among other things, with the programme sequence control unit of the machine and the heating element 30;

the power and control conductor leads (not shown, either) that connect the various component parts to the programme sequence control unit 15 and are all associated to the power supply mains via a multi-pole power-supply cable 52 passing through a water-tight aperture situated at the bottom of the back wall of the inner vessel 2—see FIG. 1.

The first centrifugal pump 21 is driven by an electric synchronous driving motor arranged thereabove in a position outside the pan-shaped body 5 (ie. not submerged in the liquor), said motor comprising an inner rotor 22 with the related electrically insulating bottom pan 23 and an outer stator 24 with the related electrically insulating support 25—see FIGS. 3 and 4.

In a largely known manner, the pump 21 operates in a closed-loop mode to supply the rotating spray arms 9, 11 and 12. To this purpose, the intake side 27 thereof communicates, via a pipe connection 26, with a collection sump 14 which, duly protected by a fine-meshed filter (not shown) at the level of the bottom 10, extends downwards from the pan-shaped body 5. On the delivery side 29 of the pump 21, downstream of the heating element 30, there is arranged the already cited ball valve 20, in which the outlets of said valve are respectively connected to the lower rotating spray arm 9 via a vertical tube 17 and, in parallel, to the upper and intermediate rotating spray arms 11, 12 via a conduit 13A which (when the door 3 is closed) is adapted to couple up with a vertical conduit 13B extending along the back wall of the inner vessel 2—see FIGS. 1 and 3.

The second centrifugal pump 31 is driven by an electric synchronous drive motor of its own, which is also arranged in a position thereabove outside the pan-shaped body 5 (ie. not submerged in the liquor) and comprises an inner rotor 32 with the related electrically insulating bottom pan 33 and an outer stator 34 with the related electrically insulating support 35. The intake side 37 of the pump 31 communicates with the collection sump 14 via a pipe connection 36, which is separate from the pipe connection 26 of the washing pump 21, whereas the delivery side 39 of the pump 31 is connected to a telescopic flexible hose 53 passing through a water-tight aperture situated at the bottom of the back wall of the inner vessel 2 (see FIGS. 1 and 2) and ensures liquor discharge from the inner vessel.

As it may be appreciated from the description given above, the advantages offered by the present invention can be summarized as follows:

A. The manufacturing efficiency made possible by and the quality of the dishwashing machine are optimized since the functional unit 15 is manufactured, assembled and electrically and hydraulically tested separately from the machine, and is then installed in a single operation on the bottom 10 of the pan-shaped body 5.

B. The functionality of the pumps 21 and 31, which make actually use of separate driving motors, and the rotating spray arms 9, 11 and 12 is a fully traditional, ie. well-proven one.

C. Also the construction of the various component parts involved is a substantially traditional and, therefore, flexible one, so that no problem arises in introducing design modifications and/or deriving variants during the production life of the dishwashing machine.

D. The unit 15 is easily separable from the bottom 10 of the pan-shaped body 5, and the shells 16 and 17 themselves, which form the housing thereof, are easily separable from each other so as to conveniently gain access to the electric-hydraulic component parts housed in said unit.

E. Any intervention that a repairman or service engineer is required to perform on component parts in the unit 15 can be carried out in a most easy and convenient manner, not only without any need for the machine to be heeled over to a slanting position, but also without having to remove the same machine from its installed position in the kitchen furniture in the case that it is a built-in model, owing to the fact that said unit is fully accessible by simply sliding the loading door 3 open.

F. The heating element 30, which is quite likely to undergo failures brought about by scale depositing thereon from the washing liquor, may even be replaced from the outside of the housing of the unit 15, which therefore does not need to be removed at all.

It will be appreciated that the scope of the present invention extends to cover other embodiments based on the same inventive principles.

It may further be appreciated that, when the unit of the present invention is installed in a dishwashing machine with a traditional architecture (ie. having a loading door which is hinged at the lower front side of the outer casing and is not connected to the dish-carrying racks), ie. is removably attached under the bottom of the washing vessel of the machine, some of the above listed advantages may somehow have a more limited extent.

1. Dishwashing machine comprising an outer casing (1) enclosing an inner washing vessel (2) that is capable of being closed frontally by a door (3) and accommodates support means (6,7) for the washload items, as well as rotating spray arms (9,11,12) associated therewith for spraying the washing liquor, and further comprising electric and hydraulic component parts, among which an electric washing pump (21), an electric drain pump (31), heating elements (30) and the like, characterized in that all electrical and hydraulic component parts are arranged in a functional unit (15) which comprises a housing (16,17) that is removably attached to the bottom of the washing vessel (2), said functional unit (15) being also provided with the outlet of a telescopic flexible hose (51) for the connection to the water supply mains, and hydraulic connection means (26,36) for the connection with a collection sump (14).

2. Dishwashing machine according to claim 1, characterized in that, in said functional unit (15), the circualtion or washing pump (21) and the drain pump (31) are arranged behind each other with a vertical axis of rotation with the respective driving motors (22, 24; 32, 34) located outside the washing vessel (2).

3. Dishwishing machine according to claim 1 or 2, chracterized in that, on the intake sides (27, 37) of said pumps (21, 31), said functional unit (15) comprises separate hydradlic connection means (26, 36) for connection with a collection sump (14) arranged on the bottom of the washing vessel (2).

4. Dishwashing machine according to any of the preceding claims, characterized in that said functional unit (15) comprises on the delivery side (29) of the washing pump (21) at least a heating element (30) for heating the washing liquor and, in a series arrangement with respect to this heating element, preferably also a valve (20) for distributing the washing liquor among the rotating spray arms (9, 11, 12).

5. Dishwashing machine according to any of the prceding claims, characterized in that the housing (16, 17) of said functional unit (15) is attached removably to the bottom of the washing vessel (2).

6. Dishwashing machine according to any of the claims 1 to 4, in which the washing vessel (2) is in part formed by a body (5) having suvstantially the shape of a pan or the like, which extends from the inner surface (4) of outer casing (1), characterized in that the housing (16, 17) of said unit (15) is removably attached under the bottom (10) of said pan-shaped body (5).

7. Dishwashing machime according to any of the preceding claims, characterized in that said unit (15) also comprises the internal end portions of at least a first telescopic flexible hose (51) for letting in the water flowing from the water supply mains, at least a power-supply cable (52), and a second telescopic flexible hose (53) for discharging the washing liquor.

8. DIshwashing machine according to any of the preceeding claims, characterized in that said unit (15) also compriises devices for controlling and monitoring the level and the temperature of the washing liquor in the washing vessel (2).

9. Dishwashing machine according to any of the preceding claims, characterixed in that said unit (15) also comprises electric power and control conductor leads for interconnecting the various electric component parts.

10. Dishwashing machine according to any of the preceding claims, characterized in that the housing of said functional unit (15) substantially consists of two separable shells (16, 17) that are preferably moulded out of a plastic material.
